(19) United States
(12) Patent Application Publication
(10) Pub. No.: US 2025/0158456 A1
(43) Pub. Date: May 15, 2025

(54) STATOR CORE FOR MOTOR

(71) Applicant: DAEWON Precision Industrial Co., LTD, Ansan-si (KR)

(72) Inventors: Jaeseok KIM, Seoul (KR); Sangwook LEE, Cheonan-si (KR); Jaeshik LEE, Seoul (KR); Sohyun KWON, Incheon (KR); Yegyun PARK, Seoul (KR)

(21) Appl. No.: 18/944,967

(22) Filed: Nov. 12, 2024

(30) Foreign Application Priority Data
Nov. 13, 2023 (KR) 10-2023-0156027

(51) Int. Cl. H02K 1/16; H02K 3/34

(52) U.S. Cl. CPC H02K 1/16; H02K 3/345; H02K 2213/03

(57) ABSTRACT

The present disclosure relates to a stator core for a motor capable of improving heat dissipation. Disclosed is a stator core for a motor, including: a laminated core formed by laminating a plurality of lamina members having an embossing formed along a circumferential direction on a radial outside thereof; and an insulation layer having a certain thickness and formed on an inner circumferential surface of a hairpin inserting hole, the hairpin inserting hole formed along a circumferential direction on a radial inside of the laminated core. With this configuration, there is an effect of improving quality of the motor as the productivity and heat dissipation is improved by forming the insulation layer without inserting the insulation paper into the hairpin inserting hole.

### CROSS REFERENCE TO RELATED APPLICATION

The present application claims priority to Korea Patent Application No. 10-2023-0156027, filed Nov. 13, 2023, the entire contents of which is incorporated herein for all purposes by this reference.

### FIELD

The present disclosure relates to a stator core for a motor, more particularly, to a stator core for a motor capable of improving heat dissipation by forming an insulation layer on a hairpin inserting hole.

### BACKGROUND

A motor is a mechanic device which obtains a rotational force from electric energy and includes a stator and a rotor. The rotor electromagnetically interworks with the stator and rotates by a force acting by a magnetic field and a current flowing through a coil.

The stator refers to a stationary part in a rotating machine such as a motor, etc., that is, a part that is fixed without rotating. For example, in the case of an inductor, the stator includes a stator core, a stator coil, etc.

Such rotor and stator may be formed with laminated cores which are manufactured by laminating lamina members, which are metal thin sheets, in the form of a plurality of layers and by integrating them.

A manufacturing method for the laminated core is known as including a method of integrally fixing the lamina member in the form of a plurality of laminated layers by using a welding fixing method using a laser welding, or an insertion fixing method using an embossing, etc.

Here, when forming the laminated core by forming the embossing in the lamina member through a punching process, laminating a plurality of lamina members and pressingly fastening the lamina members, there is a problem in that over the course of forming the embossing, the lamina members are plastically deformed and a residual stress is generated in the laminated core.

In addition, when using the insertion fixing method using an embossing, an iron loss may occur according to a position at which the embossing is formed and a size of the embossing.

Further, as disclosed in a stator system of the Korea Patent No. 10-1888805, the conventional stator has an insulation paper inserted into the hairpin inserting hole, into which a hairpin is inserted so as to increase a dielectric strength.

However, in case of inserting the insulation paper into the hairpin inserting hole, there is a problem in that a unit cost increases and productivity decreases because of a process for inserting the insulation paper. In addition, a performance of the motor deteriorates because heat dissipation is not smoothly carried out due to the insulation paper.

### PRIOR ART LITERATURE

### Patent Literature

(Patent Literature 1) Korea Patent No. 2006-0044726 (May 16, 2006)
(Patent Literature 2) Korea Patent No. 10-1888805 (Aug. 8, 2018)

### SUMMARY

The present disclosure is conceived to solve the above-described problem, and an object of the present disclosure is to provide a stator core for a motor capable of improving productivity and heat dissipation by forming an insulation layer without inserting the insulation paper into the hairpin inserting hole.

In addition, according to the present disclosure, an object of the present disclosure is to provide a stator core for a motor capable of forming the laminated core by integrally fixing a plurality of lamina members using an embossing formed in the lamina members and an insulation layer, without using an adhesive.

One embodiment is a stator core for a motor, including: a laminated core formed by laminating a plurality of lamina members having an embossing formed along a circumferential direction on a radial outside thereof; and an insulation layer having a certain thickness and formed on an inner circumferential surface of a hairpin inserting hole, the hairpin inserting hole formed along a circumferential direction on a radial inside of the laminated core.

Here, the laminated core may further include: a guide portion recessed inward from a radial outer end and formed in plurality along a circumferential direction, and the embossing may be formed between the plurality of guide portions.

In addition, the embossing may be formed between a first turning radius which is a distance from a center of the lamina member to an outermost end of the lamina member and a second turning radius which is a distance from a center of the lamina member to an innermost end of the guide portion.

Here, a width of the embossing may be formed in a circumferential direction of the lamina member, and formed to have a length which is 10 to 50% of a gap distance between the first turning radius and the second turning radius.

In addition, a length of the embossing may be formed in a circumferential direction of the lamina member, and formed to be 1 to 3 mm.

The insulation layer may include: a vertical insulation layer formed in an axial direction along an inner circumferential surface of the hairpin inserting hole; and a horizontal insulation layer radially extending from both ends of the vertical insulation layer and formed in a ring shape covering a circumference of the hairpin inserting hole.

In addition, the insulation layer may be formed to close an opening formed to pass through a radial inside in the hairpin inserting hole.

With this configuration, the laminated core may be formed by integrating a plurality of lamina members as the embossing fastens and fixes a radial outside and the insulation layer fastens and fixes a radial inside.

According to a stator core for a motor according to the present disclosure, there is an effect of improving quality of the motor as the productivity and heat dissipation is improved by forming the insulation layer without inserting the insulation paper into the hairpin inserting hole.

Further, according to the present disclosure, there is an effect of saving time and expenses because the laminated core can be formed by integrally fixing the plurality of lamina members using the embossing formed in the lamina members and the insulation layer, without using an adhesive.

### BRIEF DESCRIPTION OF THE DRAWINGS

FIG. 1 is a perspective view schematically illustrating a stator core for a motor according to an embodiment of the present disclosure.

FIG. 2 is an enlarged view schematically illustrating A area in FIG. 1.

FIG. 3 is a plan view schematically illustrating a lamina member forming a laminated core in a stator core for a motor according to an embodiment of the present disclosure.

FIG. 4 is an enlarged view schematically illustrating B area in FIG. 3.

FIG. 5 is a cross-sectional view schematically illustrating a portion at which an embossing is formed in a laminated core of a stator core for a motor according to an embodiment of the present disclosure.

FIG. 6 is a view schematically illustrating forming of an insulation layer in a laminated core of a stator core for a motor according to an embodiment of the present disclosure.

FIG. 7 is a plan view schematically illustrating a stator core for a motor according to an embodiment of the present disclosure.

FIG. 8 is an enlarged view schematically illustrating C area in FIG. 7.

FIG. 9 is a cross-sectional view schematically illustrating D-D area in FIG. 8.

FIG. 10 is a view schematically illustrating a core mold used for manufacturing a laminated core of a stator core for a motor according to an embodiment of the present disclosure.

### DETAILED DESCRIPTION

Hereinafter, a detailed description will be given as to the embodiments of the present invention with reference to the accompanying drawings.

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

The terms used in the present application are used to describe only specific embodiments or examples, and are not intended to limit the present disclosure. A singular expression can include a plural expression as long as it does not have an apparently different meaning in context.

Although not defined otherwise, all terms including technical terms and scientific terms used herein have the same meanings as those generally understood by a person having ordinary knowledge in the art to which the present invention pertains. Terms defined in a dictionary generally used are additionally interpreted as having a meaning consistent with the related art documents and contents currently disclosed, and unless defined otherwise, are not interpreted as having an ideal or very official meaning.

Hereinafter, embodiments of the present invention will be described in detail with reference to the accompanying drawings.

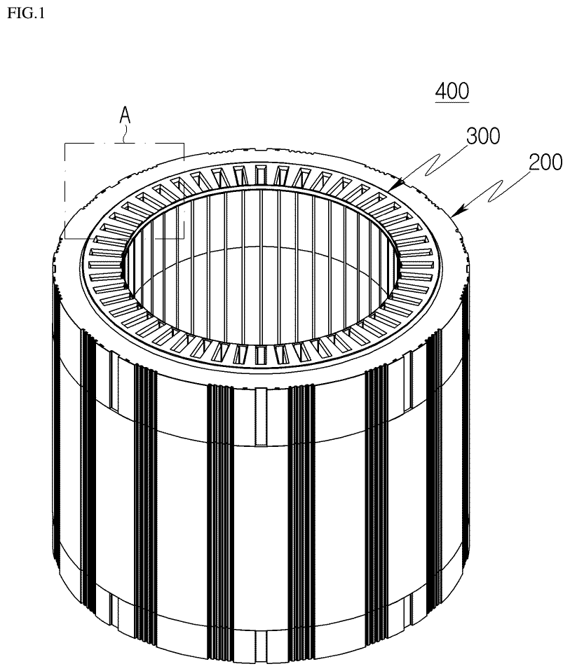

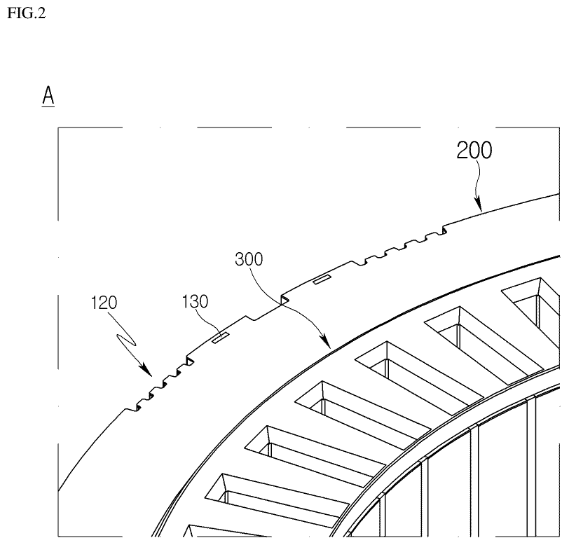

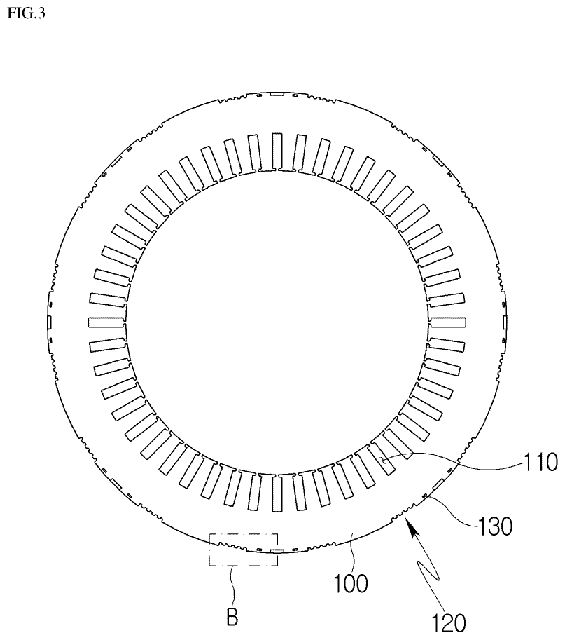

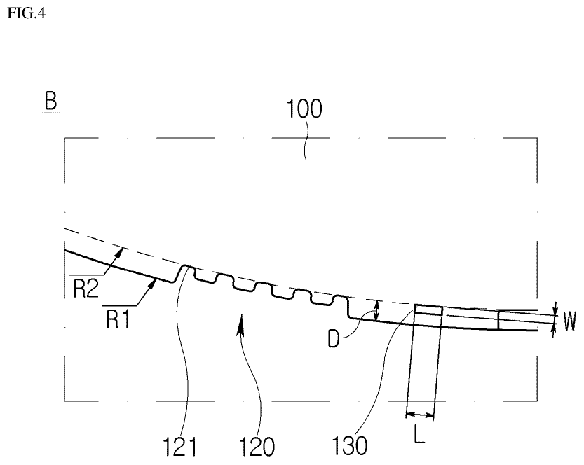

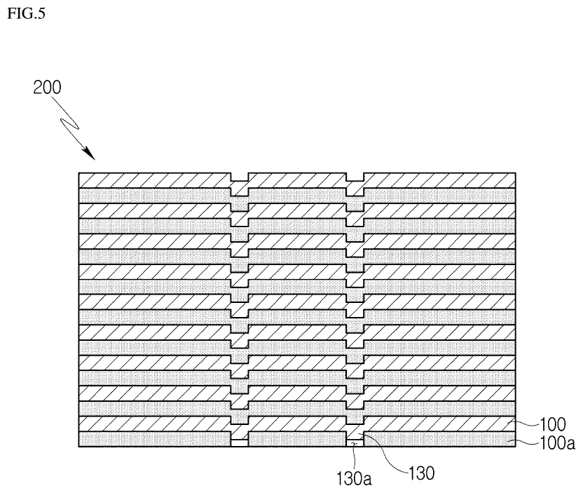

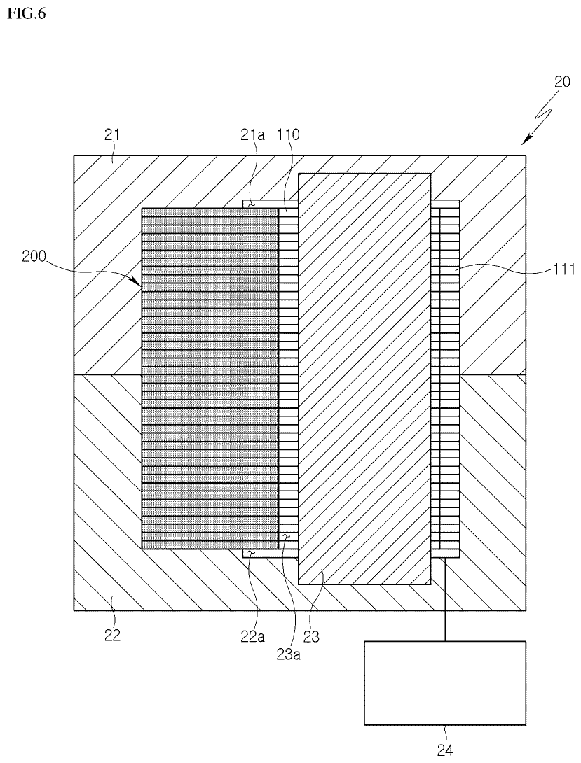

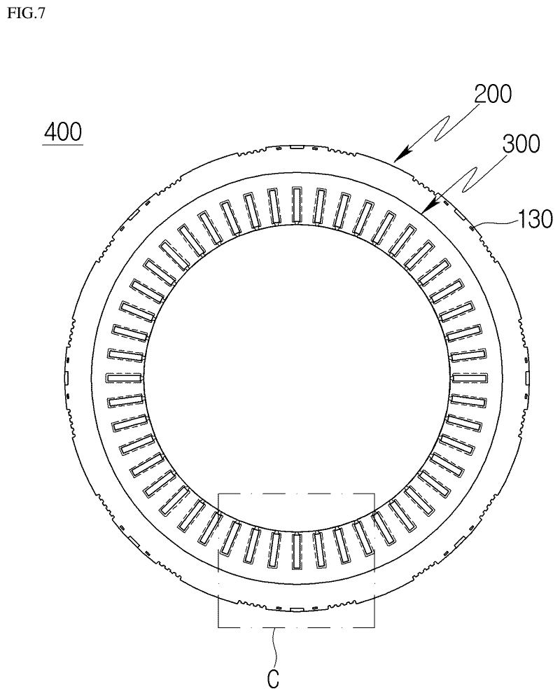

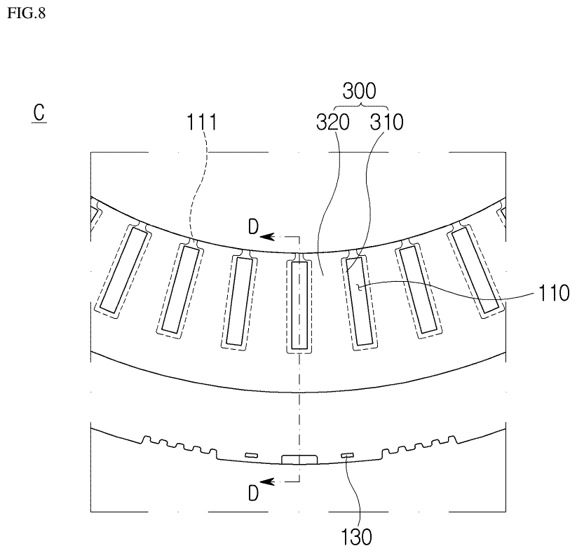

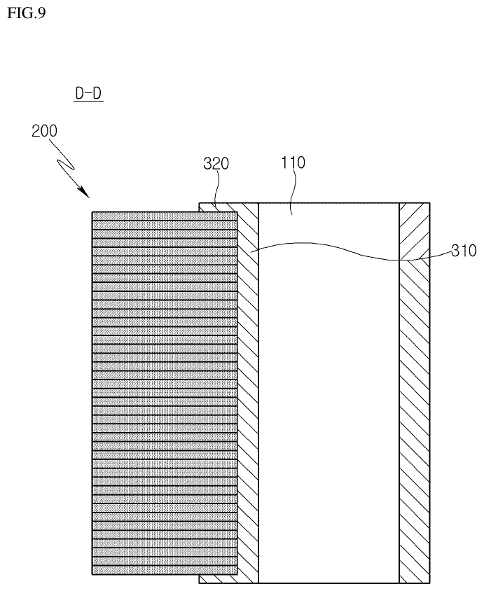

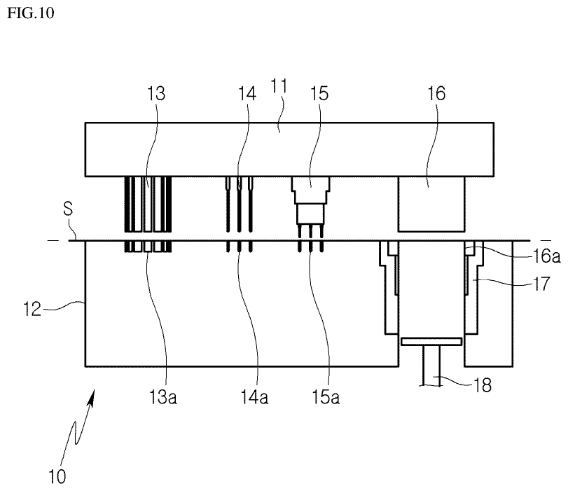

FIG. 1 is a perspective view schematically illustrating a stator core for a motor according to an embodiment of the present disclosure, and FIG. 2 is an enlarged view schematically illustrating A areas in FIG. 1. In addition, FIG. 3 is a plan view schematically illustrating a lamina member forming a laminated core in a stator core for a motor according to an embodiment of the present disclosure, and FIG. 4 is an enlarged view schematically illustrating B area in FIG. 3. Further, FIG. 5 is a cross-sectional view schematically illustrating a portion at which an embossing is formed in a laminated core of a stator core for a motor according to an embodiment of the present disclosure, and FIG. 6 is a view schematically illustrating forming of an insulation layer in a laminated core of a stator core for a motor according to an embodiment of the present disclosure. Moreover, FIG. 7 is a plan view schematically illustrating a stator core for a motor according to an embodiment of the present disclosure, FIG. 8 is an enlarged view schematically illustrating C area in FIG. 7, and FIG. 9 is a cross-sectional view schematically illustrating D-D area in FIG. 8. In addition, FIG. 10 is a view schematically illustrating a core mold used for manufacturing a laminated core of a stator core for a motor according to an embodiment of the present disclosure.

Referring to FIGS. 1 to 10, the stator core 400 for a motor according to an embodiment of the present disclosure includes a laminated core 200 formed by laminating a plurality of lamina members in which an embossing 130 is formed along a circumferential direction on a radial outside, and an insulation layer having a certain thickness and formed on an inner circumferential surface of a hairpin inserting hole 110, which is formed along a circumferential direction on a radial inside of the laminated core.

The laminated core 200 is manufactured such that the lamina member 100 is manufactured by punching and blanking a thin sheet S to be plastically deformed and the manufactured plurality of lamina members 100 are laminated and then, pressingly fastened with each other.

A stator core 400 for a motor according to the present disclosure may be manufactured by forming the insulation layer 300 on the laminated core 200 formed as described above.

More specifically, a thin sheet S is punched and a common puncture is formed in the thin sheet S provided thereto, the embossing 130 is formed by punching the thin sheet S, and then, by blanking the thin sheet S, the circular lamina member 100 is manufactured. In addition, the plurality of lamina members 100 are integrated through lamination and pressure, and the laminated core 200 is formed.

In addition, in the process for blanking the lamina member 100, a plurality of guide portions 120 recessed inward from a radial outer end of the lamina member 100 are formed.

The laminated core 200 may be manufactured by using a core mold 10 illustrated in FIG. 10.

The core mold 10 may include a slot punch 13, an embossing through-hole punch 14, an embossing punch 15, and a blanking portion 16. Here, the embossing through-hole punch 14 serves as a unit which partitions between the laminated cores 200 in the core mold 10.

The core mold 10 is a press-based device, which is divided into an upper mold 11 and a lower mold 12, and the upper mold 11 is provided with punches 13, 14, 15 and 16 for pressing and stamping, embossing, or blanking the thin sheet S.

In addition, in the lower mold 12, punch holes 13a, 14a, 15a and 16a, which correspond to the punches, are formed, a laminating barrel 17 for laminating and engaging the lamina members 100 is formed, and a laminated core seating portion 18 on which the blanked lamina member 100 is seated is provided.

In more detail, the slot punch 13 forms the hairpin inserting hole 110, into which the hairpin is inserted, on the thin sheet S, the embossing through-hole punch 14 is provided to form an embossing through-hole 130a on the thin sheet S, and the embossing punch 15 is provided to form the embossing 130 on the thin sheet S.

Here, referring to FIG. 5, the embossing through-hole punch 14 operates to form the embossing through-hole 130a only on a lamina member 100a positioned on a first floor among the plurality of lamina members 100 provided to form the laminated core 200. That is, it is configured that the embossing through-hole punch 14 forms the embossing through-hole 130a only on the lamina member 100a which is positioned on the first floor, and the embossing punch 15 forms the embossing 130 on the lamina members 100 which are to be laminated thereafter. With this configuration, it is possible to prevent formation of the embossing which protrudes outward from the lamina member 100a positioned on the first floor, and to divide the plurality of laminated cores 200 which are laminated on the laminated core seating portion 18 and are pressed thereon.

In addition, the blanking portion 16 is provided on the upper mold 11, and the blanking hole 16a facing the blanking portion 16 is formed in the lower mold 12, therefore, the lamina member 100 blanked in the thin sheet S by the blanking portion 16 is inserted into the laminating barrel 17 and laminated.

In addition, a plurality of projections and depressions (not illustrated) are formed in a height direction in the blanking portion 16 and the blanking hole 16a. When the blanking portion 16 blanks the lamina member 100, the plurality of guide portions 120 are formed along a circumference on a radial outer end of the lamina member 100 in correspondence with the plurality of projections and depressions formed in the blanking portion 16 and the blanking hole 16a.

As described above, when the guide portion 120 is formed on the lamina member 100, the lamina member 100 is seated on the laminated core seating portion 18 at a precise position without shaking during the blanking process. That is, the guide portion 120 guides the embossing of another lamina member to be laminated to be positioned on the embossing 130 of the lamina member 100 seated on the laminated core seating portion 18.

At this instance, as illustrated in FIG. 4, the guide portion 120 may be formed as a concavity in a quadrangular shape. It is apparent that the shape of the guide portion 120 is not limited thereto, but may be formed as a concavity in a polygonal shape such as a trapezoidal shape, or a triangular shape, or in a semicircular shape.

In addition, the embossing 130 is formed at a position and in a size capable of preventing an iron loss.

More particularly, the embossing 130 is formed along an outer circumference in a radial direction of the lamina member 100, and is formed to be positioned between the plurality of guide portions 120.

That is, the guide portions 120 are formed in plurality in a radial direction on an outer end of the lamina member 100, and the embossing 130 is positioned between the guide portions 120.

In addition, referring to FIG. 4, the embossing 130 is formed between a first turning radius R1 which is a distance from a center of the lamina member 100 to an outermost end of the lamina member 100 and a second turning radius R2 which is a distance from the center of the lamina member 100 to an innermost end of the guide portion 120.

That is, the guide portion 120 is formed as a groove which is recessed inward from the outer end of the lamina member 100, and the embossing 130 is formed on an inner side of an area, in which the outermost end of the lamina member 100 and an innermost end 121 of the guide portion 120 are formed.

Therefore, the embossing 130 is positioned between the plurality of guide portions 120 in a circumferential direction, and positioned between the innermost end 121 of the guide portion 120 and the outermost end of the lamina member 100 in a radial direction, and therefore, because the embossing 130 does not influence generation of the iron loss, the iron loss can be prevented.

In addition, a width W of the embossing 130 formed in a radial direction of the lamina member 100 may have a length which is 10 to 50% of a gap distance D between the first turning radius R1 and the second turning radius R2, and a length L of the embossing 130 formed in a circumferential direction of the lamina member 100 may be 1 to 3 mm.

With this sizes, the embossing 130 may be positioned between the first turning radius R1 and the second turning radius R2, and between the guide portion 120 and the guide portion 120, thereby the fastening force between the lamina members 100 can be maintained.

As described above, it is possible to prevent generation of an iron loss due to the embossing 130 by optimizing a position and a size of the embossing 130 formed to fasten between the plurality of lamina members 100.

The insulation layer 300 may be formed to have a certain thickness on an inner circumferential surface of the hairpin inserting hole 100 formed along a circumferential direction on a radial inside of the laminated core 200. The insulation layer 300 may be formed of an epoxy mold compound (EMC), which is a thermosetting resin.

Referring to FIG. 6, the insulation layer 300 may be formed by disposing the laminated core 200 on an insert mold 20 forming a cavity 23a which is inserted into the hairpin inserting hole 110 and into which a resin is injected, and filling the resin in the cavity 23a.

Here, the insert mold 20 may include a lower mold 22 and an upper mold 21 matched in shape with one another and in which the laminated core 200 is disposed, an insert pin 23 inserted into the hairpin inserting hole 110 of the laminated core 200 to form the cavity 23a and fastened to the upper mold 21 and the lower mold 22, and a resin supplying part 24 connected to at least one among the upper mold 21 and the lower mold 22 and configured to supply a resin to the mold.

With this configuration, by supplying the resin to the upper mold 21 and the lower mold 22 through the resin supplying part 24, the supplied resin is filled in the cavity 23a and the insulation layer 300 may be formed.

In addition, an upper cavity 21a and a lower cavity 22a may be formed in the upper mold 21 and the lower mold 22, respectively, such that some of the upper cavity 21a and the lower cavity 22a overlaps both ends of the laminated core 200.

With this configuration, through the cavity 23a which is a space between the hairpin inserting hole 110 and the insert pin 23, a vertical insulation layer 310 may be formed in an axial direction along an inner circumferential surface of the hairpin inserting hole 110.

In addition, through the upper cavity 21a and the lower cavity 22a, a horizontal insulation layer 320 radially extending from both ends of the vertical insulation layer 310 and formed in a ring shape covering a circumference of the hairpin inserting hole 110 may be formed.

That is, as illustrated in FIG. 7, the horizontal insulation layer 320 may be formed in a ring shape along an inner circumferential surface of the laminated core 200. In addition, the horizontal insulation layer 320 may extend radially outward from an inner end of the laminated core 200, and may cover part of an inner side of the laminated core 200 such that the horizontal insulation layer 320 is not formed to an outer end of the laminated core 200.

In addition, the insulation layer 300 may be formed to close an opening 111 penetrating a radial inside from the hairpin inserting hole 110. It is apparent that the insulation layer 300 may be formed not to close the opening 111.

As described above, the stator core for a motor 400 according to an embodiment of the present disclosure fastens and fixes a radial outside of the laminated core 200 through an embossing 130 formed along an outer circumference in a radial direction, and fastens and fixes a radial inside of the laminated core 200 through the insulation layer 300 formed along an inner circumference of the laminated core 200, thereby integrating the plurality of lamina members 100 to form the laminated core 200 without using an additional adhesive.

The present invention has been described in detail with reference to the exemplary embodiments, but the exemplary embodiments are illustrative and the present invention is not limited thereto. It is apparent that those skilled in the art may modify or improve the exemplary embodiments within the technical spirit of the present invention.

All of the simple modifications or changes of the present invention belong to the scope of the present invention, and the specific scope of the present invention may be apparent by the accompanying claims.

### REFERENCE NUMERALS

100: lamina member
110: hairpin inserting hole
111: opening
120: guide portion
121: innermost end of a guide portion
130: embossing
200: laminated core
300: insulation layer
310: vertical insulation layer
320: horizontal insulation layer
400: stator core for a motor

What is claimed is:

1. A stator core for a motor, comprising:
a laminated core formed by laminating a plurality of lamina members having an embossing formed along a circumferential direction on a radial outside thereof; and
an insulation layer having a certain thickness and formed on an inner circumferential surface of a hairpin inserting hole, the hairpin inserting hole formed along a circumferential direction on a radial inside of the laminated core.

2. The stator core for a motor of claim 1,
wherein the laminated core further comprises:
a guide portion recessed inward from a radial outer end and formed in plurality along a circumferential direction, and
wherein the embossing is formed between the plurality of guide portions.

3. The stator core for a motor of claim 2,
wherein the embossing is formed between a first turning radius which is a distance from a center of the lamina member to an outermost end of the lamina member and a second turning radius which is a distance from a center of the lamina member to an innermost end of the guide portion.

4. The stator core for a motor of claim 3,
wherein a width of the embossing is formed in a circumferential direction of the lamina member, and is formed to have a length which is 10 to 50% of a gap distance between the first turning radius and the second turning radius.

5. The stator core for a motor of claim 3,
wherein a length of the embossing is formed in a circumferential direction of the lamina member, and is formed to be 1 to 3 mm.

6. The stator core for a motor of claim 1,
wherein the insulation layer comprises:
a vertical insulation layer formed in an axial direction along an inner circumferential surface of the hairpin inserting hole; and
a horizontal insulation layer radially extending from both ends of the vertical insulation layer and formed in a ring shape covering a circumference of the hairpin inserting hole.

7. The stator core for a motor of claim 6,
wherein the insulation layer is formed to close an opening formed to pass through a radial inside in the hairpin inserting hole.

8. The stator core for a motor of claim 1,
wherein the laminated core is formed by integrating a plurality of lamina members as the embossing fastens and fixes a radial outside and the insulation layer fastens and fixes a radial inside.
